(19) United States
(12) Patent Application Publication
(10) Pub. No.: US 2026/0291197 A1
(43) Pub. Date: Sep. 24, 2026

(54) Electrical Service House Knob Socket

(71) Applicants: Phillip Bryan McBride, Roanoke, VA (US); Randy Lee McBride, Stuart, VA (US)

(72) Inventors: Phillip Bryan McBride, Roanoke, VA (US); Randy Lee McBride, Stuart, VA (US)

(21) Appl. No.: 19/570,316

(22) Filed: Mar. 18, 2026

Related U.S. Application Data
(60) Provisional application No. 63/775,663, filed on Mar. 21, 2025.

(51) Int. Cl. H02G 3/30; B25B 13/06; B25B 13/50; H02G 1/04; H02G 3/32

(52) U.S. Cl. CPC H02G 3/24; B25B 13/065; B25B 13/5008; H02G 1/04; H02G 3/32

(57) ABSTRACT

A mechanical socket that is able to quickly and efficiently install an electrical service house knob underneath of a soffit, or overhang, of a house. The house knob has a screw, a metallic part and an insulator part. The mechanical socket comprises a cylindrical housing with a first end that is adapted to receive the metallic and insulator parts of the house knob. The other end of the socket includes an adapter that allows for attachment to a power drill. After the electrical house knob is placed inside the present socket, the screw of the house knob protrudes from the socket. The installer can then use the drill and socket to drill the house knob into an exterior wall of the house, including underneath of the soffit.

### STATEMENT REGARDING FEDERALLY SPONSORED RESEARCH AND DEVELOPMENT

Not Applicable.

### FIELD OF THE INVENTION

This invention relates to the field of mechanical sockets, and more particularly to a socket that is specifically designed for an electrical service house knob.

### BACKGROUND

In order to receive electrical service from an electrical service provider, a house must first have an electrical service house knob attached to the exterior of the house. The electrical service house knob includes an insulator that allows electricity to be efficiently and safely transferred to the house.

The current method of installing electrical service house knobs includes predrilling a hole in the exterior of the house and hand screwing the house knob into the predrilled hole, as far as possible. After that, the installer puts the shaft of an extra-long screwdriver through a gap in the house knob and using the screwdriver shaft as a hand crank, continues screwing in the house knob, until it is fully seated against the house.

FIG. 1 shows a traditional electrical service house knob 100. The house knob 100 has two insulator parts 104 & 105 and a gap 106 that is between the two insulator parts. This gap 106 is the space that allows for passage of a screwdriver shaft for use as a hand crank, during the traditional installment method. The screw 101 of the house knob 100 is screwed into the predrilled hole in the exterior of the house, until the metal base 102 of the house knob 100 is seated against the house. The house knob 100 also includes two metallic arms 103 that secure the insulator parts 104 & 105 in place.

The current installment method is deficient in many respects. First of all, pressing a metal screw driver shaft against an insulator part made of ceramics, is just asking the insulator part to crack and become compromised. Secondly, using a long shaft as a hand crank requires a lot of room to operate. So, it is extremely difficult to place an electrical service house knob up underneath of an overhang, such as a soffit, using the traditional installment method. Under soffits is one of the best places to install house knobs.

Therefore, there is a need for a device that allows for fast, safe, efficient installment of electrical service house knobs. The ideal device would allow electrical house knobs to be easily installed underneath of overhangs and soffits. The present invention accomplishes these objectives.

### SUMMARY OF THE INVENTION

The present device is a mechanical socket that is able to quickly and efficiently install an electrical service house knob on an exterior wall of a house in a location underneath of a soffit. The electrical service house knob has a screw, a metallic part and an insulator part. The mechanical socket comprises a cylindrical housing. The cylindrical housing has a first end that is adapted to receive the metallic and insulator parts of the electrical service house knob. The second end of the cylindrical housing is adapted for attachment to an electrical drill. After the metallic and insulator parts are inside the cylindrical housing, the screw of the house knob protrudes from the socket and an installer can use the socket and drill to screw the house knob into the exterior wall of the house.

The house knob is secured inside the cylindrical housing with a cushion covered bolt. The bolt passes through the gap in the insulator part of the house knob and is secured with a nut in the opposite side of the cylinder. Alternatively, the interior of the cylindrical housing can be complementary in shape to that of the house knob. And, the snug fit inside the cylindrical housing secures the house knob in place during rotation of the socket by the drill. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a frontal view of an electrical service house knob;

FIG. 2 is a side view of the electrical service house knob;

FIG. 3 is a cross-sectional view of the first embodiment of the present invention;

FIG. 4 is an exterior view of the first embodiment of the present invention;

FIG. 5 is a cross-sectional view of the second embodiment of the present invention;

FIG. 6 is an exterior view of the second embodiment of the present invention;

FIG. 7 is a flow chart showing the steps for using the present invention; and,

FIG. 8 shows an electrical service house knob in operational position.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

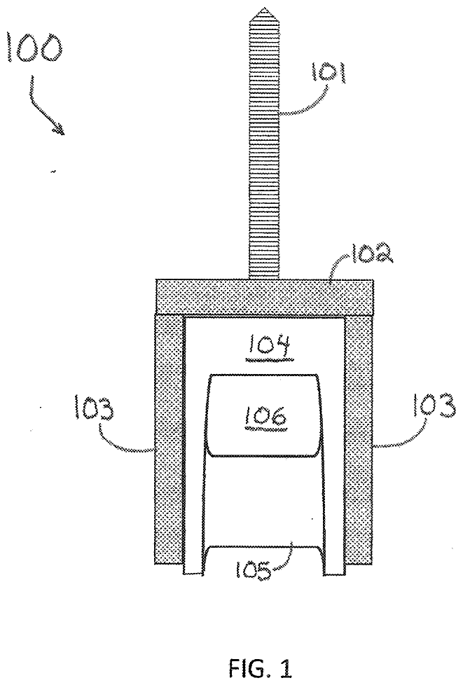

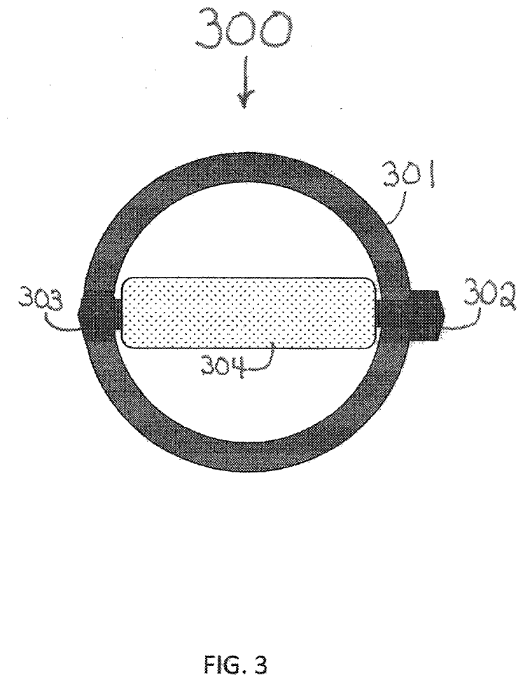

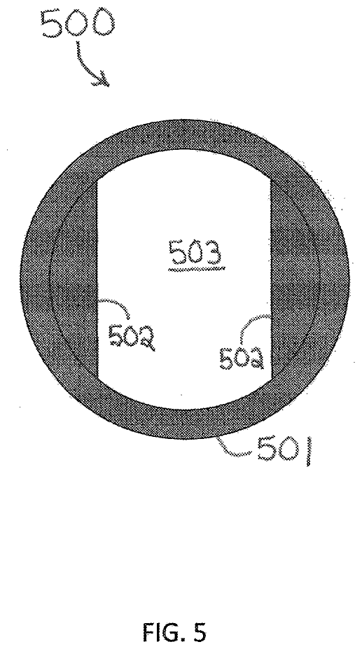

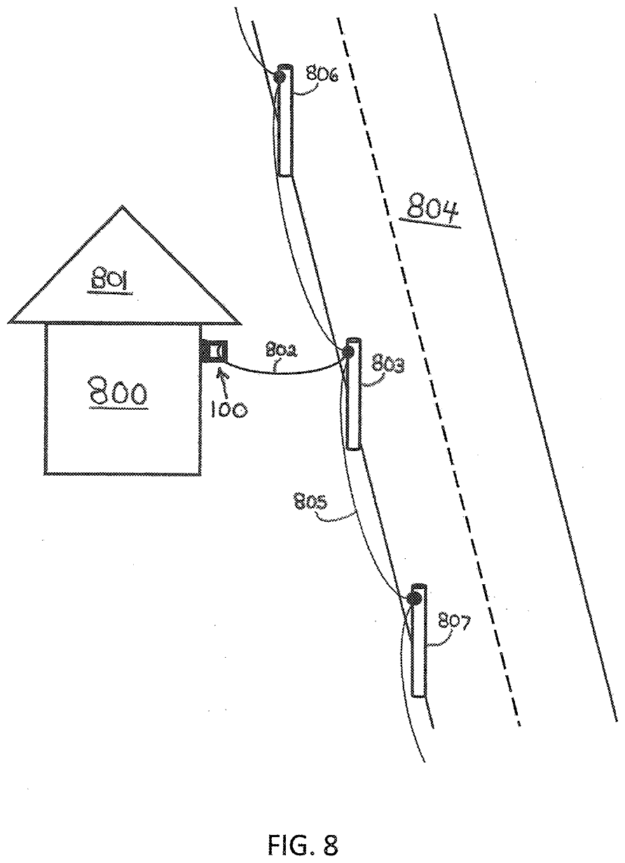

FIG. 1 shows a traditional electrical service house knob 100 that must be installed on the outside of every house that wants to receive electrical service from the local electric company. The house knob 100 has two insulator parts 104 & 105 and a gap 106 that is between the insulator parts. The gap 106 allows for acceptance and securing of a drop wire from the power line that runs along the street in front of the house, shown in FIG. 8. The gap 106 also allows for passage of a screwdriver shaft for use as a hand crank to screw the house knob 100 into an exterior wall, using the traditional installation method. The present invention greatly improves on the traditional installation method. In the first embodiment of the present socket, a cushioned bolt is used to extend through the gap 106 between the two insulator parts. The first embodiment is discussed further below in conjunction with FIGS. 3 & 4. The house knob 100 also includes two metallic arms 103 that secure the insulator parts 104 & 105 in place. These two metallic arms 103 provide two flat sides for the house knob 100. These flat sides can be used to secure the knob 100 within the second embodiment of the present socket and are discussed further below in conjunction with FIG. 5.

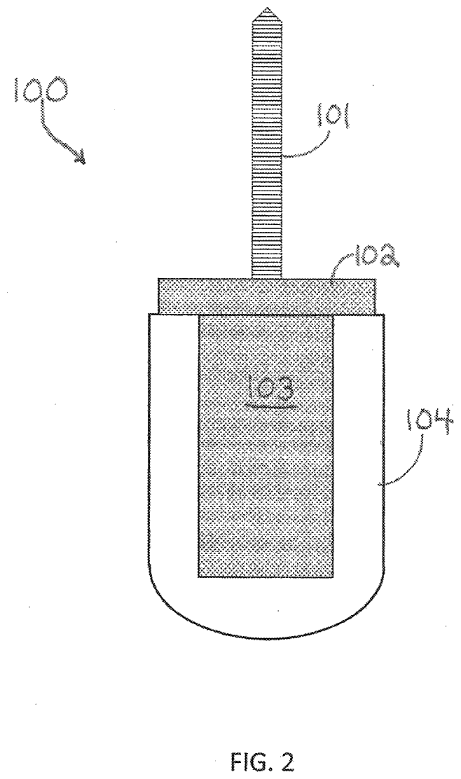

FIG. 2 is a side view of the traditional electrical service house knob 100 showing the screw 101, metal base 102, one of two metallic arms 103 and ceramic part 104. The two metallic arms 103 provide two flat sides on the house knob 100. These flat sides are used in the second embodiments of the present socket to secure the house knob 100 within the socket. The second embodiment of the present socket is discussed further below in conjunction with FIGS. 5 & 6.

FIG. 3 is a cross-sectional view of the first embodiment 300 of the present invention. The present house knob socket 300 is a mechanical socket that holds an electrical service house knob in its interior and allows the house knob to be screwed into a wall using an electric drill. The drill is preferably a battery powered drill. The first embodiment of the house knob socket 300 comprises a cylindrical housing 301, a bolt 302 that extends across a diameter of the housing 301, and a nut 303 that secures the bolt 302 in place. The bolt 302 is provided with a foam cushion 304 that surrounds the shaft of the bolt 302. The cushion 304 prevents the ceramic part of the house knob from being damaged during rotation/installation of the knob. Besides foam, the cushion 304 can also be made of rubber or another soft, cushioning material. The other parts, including the cylindrical housing 301, the nut 303 and bolt 302, are made metal or a metal alloy. In the preferred embodiment, the cylindrical housing 301 has a length of 2¾ inches or 2⅞ inches. However, the cylindrical housing 301 can have other lengths, including shorter and longer lengths, in other embodiments.

In operation, the bolt 302 is removed from the socket 300 and a house knob 100 is inserted into the interior of the cylindrical housing 301. The bolt 302 is then re-inserted so that it passes through the gap 106 in the house knob 100 and the bolt 302 is secured in place using nut 303. The gap 106 in the house knob 100 is shown in FIG. 1. The nut 303 is preferable permanently attached to the housing 301. At this point, the house knob 100 and socket 300 assembly are attached to a drill and the house knob can be drilled/screwed into an exterior wall of a house. A guide hole does not need to be pre-drilled using this improved installation device and method, however, a guide hole can optionally be pre-drilled, if desired. In the preferred embodiment, the interior of the housing 301 has a diameter of 2¼ inches. This interior diameter is complementary in size to standard sized electrical service house knobs. Other diameters, including smaller and larger diameters, can be used with other embodiments of the present invention.

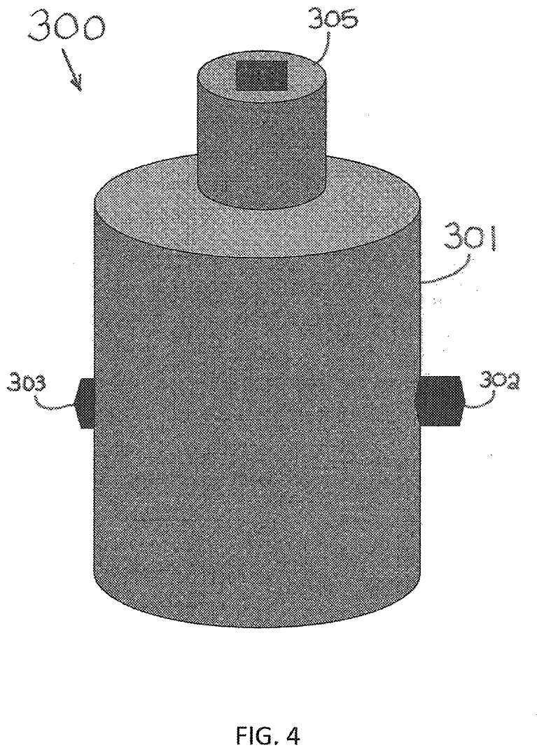

FIG. 4 is an exterior view of the first embodiment of the present socket 300. The cylindrical housing 301 has a large opening at one end that receives the house knob. In the preferred embodiment, the large opening has a diameter of 2¼ inches. The housing 301 has an adapter 305, at the opposite end of the large opening, that allows for temporary attachment to an electric drill, or to a hand powered wrench, such as a wrench for a drive socket set. In the preferred embodiment, the adapter 305 has a size of a ½ inch which allows for direct attachment to a ½ inch socket set wrench. An electric drill, with a similar drive as the socket set wrench, is used in the preferred embodiment to provide the rotational power required to screw the house knob into the wall of the house. The adapter 305 can be provided in multiple shapes and sizes to allow attachment of almost any power drill and socket wrench, including standard and metric sizes. The adapter 305 can also be provided with flat exterior sides that simulate the sides of drill bit, so it fits inside traditional electric drills. The cushioned bolt 302 and the nut 303 extend through the interior of the housing 301 and secure the house knob within the socket during rotation of the socket 300, in this first embodiment.

FIG. 5 is a cross-sectional view of the second embodiment 500 of the present invention. This embodiment 500 does not use a bolt to secure the house knob 100 in the interior 503 during installation. Instead, this embodiment 500 takes advantage of the two flat sides provided by the two metallic arms 103 in traditional house knobs 100. The cylindrical housing 501 of this socket 500 includes two flat sides 502 in the interior 503 of the housing 501. These two flat sides 502 in the interior 503 are complementary to the two flat sides of traditional house knobs 100. After the house knob 100 is inserted into the socket 500, the two flat sides 502 inside the housing 501 engage with the two flat metallic arms 103 of the house knob 100 and prevent the house knob from rotating in the socket 500 during drilling/installation. The housing 501 of the socket, at its widest part, preferably has a diameter of 2¼ inches. However, other diameters, including larger and smaller diameters, can be provided in other embodiments. The cylindrical housing 501 and the flat sides 502 are preferably made metal or a metal alloy.

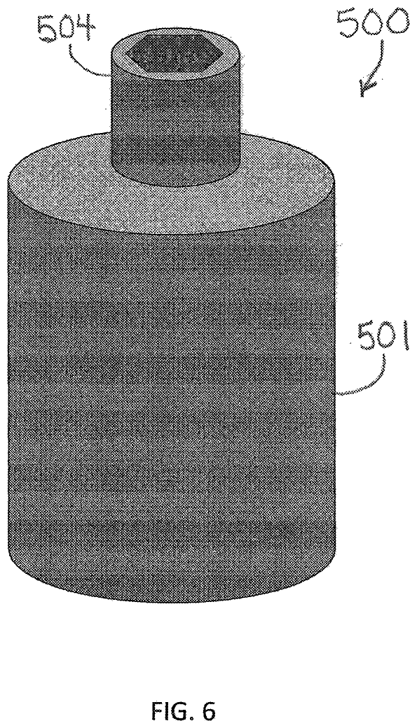

FIG. 6 is an exterior view of the second embodiment 500. The socket 500 includes a cylindrical housing 501 and an adapter 504 that allows for temporary attachment to a drill or wrench. The adapter 504 can be provided in multiple shapes and sizes to allow attachment of almost any power drill and socket wrench, including standard and metric sizes. Preferably, an electric drill is used to provide the rotational power required to turn the socket 500 and screw a house knob 100 into an exterior wall of a house. Preferably, the adapter 504 is a ½ inch drive socket set attachment and is made of metal or a metal alloy. Preferably, the cylindrical housing 501 has a length of 2¾ inches or 2⅞ inches. However, the cylindrical housing 501 can have other lengths, including longer and shorter lengths, in other embodiments.

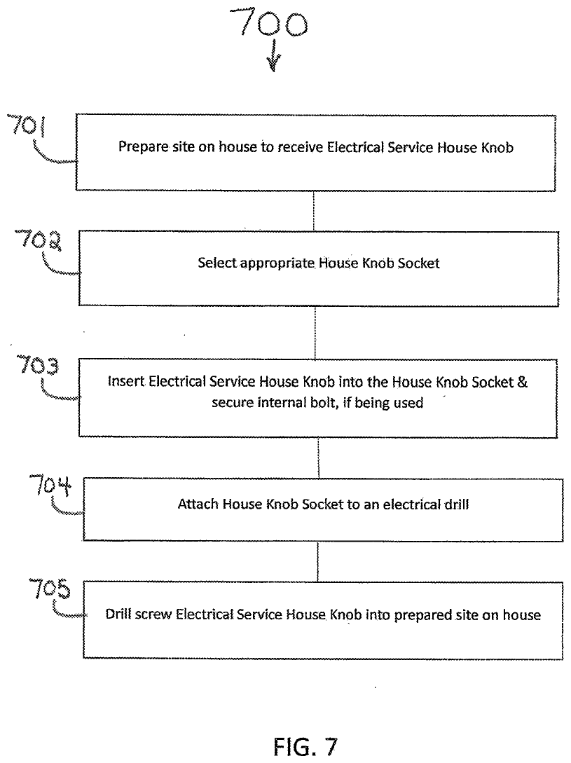

FIG. 7 is a flow chart 700 showing exemplary steps for using the present invention. In step 701, a location on the house, for installation of the electrical service house knob, is selected and the location is prepared for installation. One of the best sites for placement of a house knob is just under a soffit, or roof overhang, of the house. The present invention is excellent for placing house knobs underneath of soffits. Site preparation without the present house knob socket required pre-drilling a hole at the site with a drill bit that had a diameter that was slightly smaller than the diameter of the screw on the house knob. With the present socket, no pre-drilling is required. Thus, site preparation merely requires deciding on, and possibly marking, the location on the house where the house knob is to be placed. In step 702, the installer selects the appropriate socket for the job. If the installer has a socket that matches the flat sides of the house knob, they can select that socket. Custom sockets can be produced that match any house knob. Otherwise, the installer selects the first embodiment socket that does not require matching the size and shape of the house knob. In step 703, the electrical service house knob is inserted into the selected house knob socket. If the first embodiment of the house knob socket was selected, the cushioned bolt is then inserted through the gap in the house knob and secured in place with the nut. If the second embodiment of the house knob socket is used, no bolt is required to secure the houses knob within the socket. In step 704, the present socket with the house knob inside it is attached to an electric drill using the adapter of the socket. At this point, the screw of the house knob is protruding out of the socket. In step 705, the socket is used to screw the electrical service house knob into the exterior wall of the house using the power drill. Step 705 is a giant leap forward for electricians that, up until now, had to install house knobs by hand. Having to use a long screwdriver to hand crank the house knob into place prevented installation up close to the overhang, or soffit, of the house. Now, electricians can use an electric drill and place electrical service house knobs in the best possible location, up close to soffits. Further, the present invention allows installation of house knobs to be automated, meaning faster, safer and more efficient.

FIG. 8 shows an electrical service house knob 100 in its operational position, which is screwed into the side of a house 800, preferably under the overhang, or soffit, of the roof 801 of the house 800. The house knob 100 allows a drop wire 802 to be connected to the house 800, thereby providing electrical service to the house 800. The drop wire 802 is connected to the electrical supply wire 805 that runs along the road 804 in front of the house 800. The electrical supply wire 805 is suspended above the road 804 by telephone poles 803, 806 & 807 and the supply wire 805 is connected to the local electric company.

While a particular form of the invention has been illustrated and described, it will be apparent that various modifications can be made without departing from the spirit and scope of the invention. For example, the cylindrical housing could have a different cross-sectional shape other than circular. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A mechanical socket that is adapted for installation of an electrical service house knob on an exterior wall of a house, the electrical service house knob having a screw, a metallic part and an insulator part, the mechanical socket comprising:
a cylindrical housing, the cylindrical housing having a first end that is adapted to receive the metallic and insulator parts of the electrical service house knob, and the cylindrical housing having a second end that is adapted for attachment to a drill, wherein after the metallic and insulator parts are received in the first end of the cylindrical housing, the screw of the house knob protrudes from the socket, and an installer can use the drill and the mechanical socket to drill the electrical service house knob into the exterior wall of the house.

2. The mechanical socket of claim 1, wherein the socket further comprises:
an interior, a bolt, a nut and a cushion, wherein the bolt removably extends across the interior of the socket and can be secured in place using the nut, and wherein the cushion surrounds a shaft of the bolt;
the bolt is adapted to pass through a gap in the insulator part of the electrical service house knob thereby keeping the house knob from rotating inside the socket during installation/drilling of the house knob into the house.

3. The mechanical socket of claim 1, wherein the cylindrical housing has an interior that includes two flat sides, the flat sides being on opposite sides of the interior and providing the interior of the cylindrical housing with a form fitting shape and size that is complementary to that of the electrical service house knob, the flat sides being adapted for contact with the metallic parts of the house knob when the house knob is inserted into the socket.

4. The mechanical socket of claim 1, wherein the second end that is adapted for attachment to a drill is provided in multiple sizes, including standard and metric sizes, different embodiments of the socket.

5. The mechanical socket of claim 1, wherein the drill is an electric drill.

6. The mechanical socket of claim 1, wherein the socket has an interior with a diameter of 2¼ inches.

7. The mechanical socket of claim 1, wherein the cylindrical housing has a length of 2⅞ inches.

8. The mechanical socket of claim 1, wherein the second end of the cylindrical housing comprises a ½ inch drive socket set attachment.

9. The mechanical socket of claim 2, wherein the nut is permanently attached to the cylindrical housing.

10. The mechanical socket of claim 1, wherein the mechanical socket is made of metal or a metal alloy.

11. A method of installing an electrical service house knob onto an exterior wall of a house, the method using a mechanical socket that is adapted for installation of the electrical service house knob, the mechanical socket comprising a cylindrical housing, the cylindrical housing having a first end that is adapted to receive the electrical service house knob, and a second end that is adapted for attachment to a drill, the method comprising the steps of:
deciding on an appropriate site on the exterior wall of the house to receive the electrical service house knob;
selecting the appropriate mechanical socket for the house knob to be installed;
inserting the electrical service house knob into the mechanical socket;
securing an internal bolt to a nut to lock the house knob in place, if required by the selected mechanical socket;
attaching the mechanical socket to a drill; and,
drilling a screw of the house knob into the prepared site on the house.

12. The method of claim 11, wherein the internal bolt includes a cushion surrounding a shaft of the bolt, and the bolt is adapted to pass through a gap in an insulator part of the electrical service house knob, wherein the internal bolt keeps the house knob from rotating inside the socket during installation/drilling of the house knob into the house.

13. The method of claim 11, wherein the cylindrical housing has an interior that includes two flat sides, the flat sides being on opposite sides of the interior and providing the interior of the cylindrical housing with a form fitting shape and size that is complementary to that of the electrical service house knob, the flat sides being adapted for direct contact with the house knob.

14. The method of claim 11, wherein the second end of the cylindrical housing that is adapted for attachment to a drill is provided in different embodiments in both standard and metric sizes.

15. The method of claim 11, wherein the step of attaching the mechanical socket to a drill, further comprises attaching the mechanical socket to an electric drill.

16. The method of claim 11, wherein the mechanical socket has an interior with a diameter of 2¼ inches.

17. The method of claim 11, wherein the cylindrical housing has a length of 2⅞ inches.

18. The method of claim 11, wherein the second end of the cylindrical housing comprises a ½ inch drive socket set attachment.

19. The method of claim 11, wherein the nut is permanently attached to the cylindrical housing.

20. The method of claim 11, wherein the mechanical socket is made of metal or a metal alloy.
